(19) United States
(12) Patent Application Publication
(10) Pub. No.: US 2024/0240282 A1
(43) Pub. Date: Jul. 18, 2024

(54) Method for Denitration of Carbothermally Reduced Iron-Containing Nonferrous Metal Smelting Slag Mixed With Advanced Oxidizer

(71) Applicants: Kunming University of Science and Technology, Yunnan (CN); Jiangxi Blue Environmental Engrg Tech Co., Ltd., Pingxiang (CN); Yunnan Blue Enviromental Engineering Tech Co., Ltd., Yunnan (CN)

(72) Inventors: Xin SUN, Yunnan (CN); Kai LI, Yunnan (CN); Jie YANG, Yunnan (CN); Yaqiong LUO, Yunnan (CN); Xiaomei JIANG, Yunnan (CN); Wanting ZHANG, Yunnan (CN); Minghui HE, Yunnan (CN); Xin TANG, Yunnan (CN); Wenping QIAN, Yunnan (CN)

(21) Appl. No.: 18/415,220

(22) Filed: Jan. 17, 2024

(30) Foreign Application Priority Data
Jan. 17, 2023 (CN) 202310080985.2

(51) Int. Cl. C22B 7/04; C22B 5/10

(52) U.S. Cl. CPC C22B 7/04; C22B 5/10

(57) ABSTRACT

Provides is a method for denitration of carbothermally reduced iron-containing nonferrous metal smelting slag mixed with advanced oxidizer. In the method, the iron-containing smelting slag is subjected to carbothermal reduction, such that metals or metal oxides in the smelting slag are reduced and transformed into active catalysts which could activate hydrogen peroxide to generate free radicals. Hydrogen peroxide is catalytically decomposed, generating ·OH free radicals, and ·OH free radicals generated further oxidize NOₓ. The reactions are performed at ambient temperature

### CROSS-REFERENCE TO RELATED APPLICATION

This patent application claims the benefit and priority of Chinese Patent Application No. 202310080985.2 filed with the China National Intellectual Property Administration on Jan. 17, 2023, the disclosure of which is incorporated by reference herein in its entirety as part of the present application.

### TECHNICAL FIELD

The disclosure relates to the technical field of intersection of environmental engineering and metallurgical engineering, in particular to a method for denitration of carbothermally reduced iron-containing nonferrous metal smelting slag mixed with advanced oxidizer.

### BACKGROUND

Waste slags produced in the process of nonferrous metal smelting are large in quantity and variety. At present, nonferrous metal smelting slags have an annual discharge of about 50 million tons, most of which are stacked in open air and have not been utilized as resources. Because smelting slags are rich in heavy metals, stacking of the smelting slags in an open air slag yard for a long time often causes different degrees of pollution to the surrounding environment through different ways of migration or transformation of the smelting slags. Moreover, many smelting slags also contain available metal resources, which are harmful to discard and valuable to use. Copper slags, zinc slags, lead slags, steel slags and nickel slags are typical solid wastes of FeO—SiO₂ nonferrous metal smelting industry with high iron contents, and the iron mainly exists in the form of ferrous irons. While in the process of slag discharge, the iron in the slags mainly exists in the form of a fayalite (Fe₂SiO₄) phase or a RO phase (an infinite solid solution of divalent metal oxides MgO, FeO and MnO). Iron element is wrapped in glass body with fine embedded particle sizes, and is often embedded with other minerals, making it difficult to directly use the iron element.

Nitrogen oxides (NOₓ) are important factors for forming acid rain, and are also one of the important precursors for photochemical pollution and ultrafine particles (PM2.5). Also, NOₓ could react with ozone and destroy the ozone layer. Therefore, controlling NOₓ emission is of great scientific significance for improving the atmospheric environment. At present, NOₓ is controlled by a combination of wet flue gas desulfurization (WFGD) and selective catalytic reduction (SCR), but in the selective catalytic reduction technology, catalyst cost accounts for 30-55% of investment cost, and catalyst activity is low at low temperature. Moreover, there are also problems such as potential ammonia leakage and N₂O by-products, which have a great impact on the removal of NOₓ at low temperature. In recent years, an integrated wet flue gas desulfurization and denitrification developed from WFGD is considered to be a more promising removal process at low temperature, because there are no problems of SCR technology. In the traditional wet flue gas desulfurization, calcium-based absorbents are mainly used, and a typical process is a limestone-gypsum method. However, a large number of low-grade gypsum produced by calcium-based desulfurization technology is difficult to be consumed by markets at present, and hundreds of millions of tons of stacking desulfurized gypsum have caused serious solid waste pollution and disposal problems.

### SUMMARY

An object of the present disclosure is to provide a method for denitration of carbothermally reduced iron-containing nonferrous metal smelting slag mixed with advanced oxidizer. A smelting slag after carbothermal reduction is used as a heterogeneous reagent for wet denitration, which could not only realize a reuse of the smelting slag, but also do not produce secondary pollution during the denitration process, and could achieve a good denitration efficiency at low temperature.

In order to achieve the above object, the present disclosure provides the following technical solutions:

Provided is a method for denitration of carbothermally reduced iron-containing nonferrous metal smelting slag mixed with advanced oxidizer, including:
mixing an iron-containing nonferrous metal smelting slag and a carbon reducing agent to obtain a mixture, and subjecting the mixture to carbothermal reduction at a temperature of 600-900° C. in a protective atmosphere to obtain a reduction product;
mixing the reduction product and water to obtain a slag slurry; and
mixing the slag slurry, a hydrogen peroxide solution and an NOₓ-containing flue gas to obtain a mixed material, and subjecting the mixed material to denitration.

In some embodiments, in the iron-containing nonferrous metal smelting slag, a mass fraction of iron oxide is in a range of 35-70%, and iron ions mainly exist in the form of ferrous irons in the iron-containing nonferrous metal smelting slag.

In some embodiments, the carbon reducing agent is selected from the group consisting of lignite, anthracite, bituminous coal, and biomass.

In some embodiments, a mass ratio of the iron-containing nonferrous metal smelting slag to the carbon reducing agent is in a range of 1:0.02 to 1:0.16.

In some embodiments, the carbothermal reduction is conducted for 0.5-1.0 h.

In some embodiments, a solid-liquid ratio of the reduction product to water is in a range of 1 g:100 ml to 1 g:250 ml.

In some embodiments, hydrogen peroxide in the hydrogen peroxide solution is in an amount of 1.5 mol to 5 mol per liter of the slag slurry; and the hydrogen peroxide solution has a hydrogen peroxide mass fraction of 35%.

In some embodiments, the NOₓ-containing flue gas has an NOₓ concentration of 250-500 ppmv.

In some embodiments, the denitration is performed at a temperature of 45-65° C. and a pH value of 9-11.

In some embodiments, the carbon reducing agent has a particle size such that the carbon reducing agent passes through a 200-mesh screen.

The present disclosure provides a method for denitration of carbothermally reduced iron-containing nonferrous metal smelting slag mixed with advanced oxidizer, including: mixing an iron-containing nonferrous metal smelting slag with a carbon reducing agent to obtain a mixture, and subjecting the mixture to carbothermal reduction at a temperature of 600-900° C. in a protective atmosphere to obtain a reduction product; mixing the reduction product and water to obtain a slag slurry; and mixing the slag slurry, a hydrogen peroxide solution, and an NOₓ-containing flue gas to obtain a mixed material, and subjecting the mixed material to denitration. In the present disclosure, the smelting slag and the carbon reducing agent are subjected to reduction roasting in a protective atmosphere to realize phase transformation, and a resulting reduction product is controlled to include magnetite (Fe₃O₄) and zero-valent iron (Fe⁰) as main transition metal active substances. Then, the reduction product is mixed with water to obtain a slag slurry, the slag slurry is put into a denitration reactor, and a hydrogen peroxide solution is added thereto, such that transition metals and the hydrogen peroxide solution could generate active free radicals, and hydrogen peroxide is catalytically decomposed, generating ·OH free radicals. ·OH free radicals generated could further oxidize NOₓ into soluble high-valent NOₓ. The high-valent NOₓ could enter a liquid phase, and then be absorbed by the slag slurry to realize denitration. The method of the present disclosure could solve the problem of NOₓ emission in the process of industrial furnace flue gas smelting while reusing the iron-containing smelting slag, and would not produce secondary pollution.

### BRIEF DESCRIPTION OF THE DRAWINGS

FIGURE is a diagram showing the change of denitration efficiency over time in Examples 1 to 4 of the present disclosure.

### DETAILED DESCRIPTION OF THE EMBODIMENTS

The present disclosure provides a method for denitration of carbothermally reduced iron-containing nonferrous metal smelting slag mixed with advanced oxidizer, including:
mixing an iron-containing nonferrous metal smelting slag and a carbon reducing agent to obtain a mixture, and subjecting the mixture to carbothermal reduction at a temperature of 600-900° ° C. in a protective atmosphere to obtain a reduction product;
mixing the reduction product and water to obtain a slag slurry; and
mixing the slag slurry, a hydrogen peroxide solution and an NOₓ-containing flue gas to obtain a mixed material, and subjecting the mixed material to denitration.

In the present disclosure, an iron-containing nonferrous metal smelting slag is mixed with a carbon reducing agent to obtain a mixture, and the mixture is subjected to carbothermal reduction in a protective atmosphere to obtain a reduction product.

In some embodiments, in the iron-containing nonferrous metal smelting slag, a mass fraction of iron oxide is in a range of 35-70%, and iron ions mainly exist in the form of ferrous irons in the iron-containing nonferrous metal smelting slag. In some embodiments, the iron-containing nonferrous metal smelting slag includes at least one of a copper slag, a lead slag, a zinc slag, a nickel slag, a steel slag, and a ferrochromium slag. In some embodiments of the disclosure, in the copper slag, the ferrous irons mainly exist in the form of fayalite and magnetite; in a vanadium slag, iron-containing phases mainly are fayalite (2FeO·SiO₂), iron oxide (Fe₂O₃) and calcium fayalite (CaFe[Si₂O₆]) in a small amount; in the nickel slag, iron-containing phases mainly are fayalite (2FeO·SiO₂) and magnesium fayalite; and in the steel slag, the iron mainly exists in the form of calcium ferrite and RO phase.

In some embodiments of the present disclosure, the carbon reducing agent includes a lignite, an anthracite, a bituminous coal, or a biomass. In some embodiments of the present disclosure, the carbon reducing agent has a particle size such that the carbon reducing agent passes through a 200-mesh screen.

In some embodiments, before mixing the iron-containing nonferrous metal smelting slag and the carbon reducing agent, the iron-containing nonferrous metal smelting slag is crushed and ball milled. In some embodiments, a resulting ball milled carbon reducing agent has a particle size such that the resulting ball milled carbon reducing agent passes through a 100-mesh screen.

In some embodiments, a mass ratio of the iron-containing nonferrous metal smelting slag to the carbon reducing agent is in a range of 1:0.02 to 1:0.16, preferably 1:0.05 to 1:0.12, and more preferably 1:0.08 to 1:0.1. In some embodiments, the carbothermal reduction is carried out in a tube furnace. In some embodiments, the protective atmosphere is a nitrogen atmosphere.

In some embodiments, the carbothermal reduction is performed at a temperature of 600-900° C., preferably 650-850° C., and more preferably 700-800° C. In some embodiments, the carbothermal reduction is performed for 0.5-1 h. In some embodiments, the mixture is heated to the carbothermal reduction temperature at a heating rate of 3-15° C./min, and preferably 5-10° C./min. In the present disclosure, during the carbothermal reduction, fayalite-containing phase(s) would be transformed into magnetite (Fe₃O₄) and zero-valent iron (Fe⁰). In the present disclosure, iron-containing phase(s) in the reduction product mainly exists in the form of magnetite (Fe₃O₄) and/or zero-valent iron (Fe⁰).

After the reduction product is obtained, the reduction product is mixed with water to obtain a slag slurry.

In some embodiments, a solid-liquid ratio of the reduction product to water is in a range of 1 g:100 ml to 1 g:250 ml, preferably 1 g:150 ml to 1 g:200 ml, and more preferably 1 g:180 ml to 1 g:200 ml. In some embodiments, the reduction product and the water is mixed by stirring.

After the slag slurry is obtained, the slag slurry is mixed with the hydrogen peroxide solution and the NOₓ-containing flue gas to obtain a mixed material, and the mixed material is subjected to denitration.

In some embodiments, hydrogen peroxide in the hydrogen peroxide solution is in an amount of 1.5 mol to 5 mol per liter of the slag slurry, preferably 2 mol to 4 mol per liter of the slag slurry, and more preferably 2.5 mol to 3.5 mol per liter of the slag slurry. In some embodiments of the present disclosure, the hydrogen peroxide solution has a hydrogen peroxide mass fraction of 35%. In some embodiments, the NOₓ-containing flue gas has an NOₓ concentration of 250-500 ppmv, and preferably 300-450 ppmv. In the present disclosure, there is no special limitation on the source of the NOₓ-containing flue gas, and any source of the NOₓ-containing flue gas well-known to those skilled in the art could be used. In the examples of the present disclosure, the NOₓ-containing flue gas is simulated by a mixture of oxygen, nitric oxide and nitrogen, and the NOₓ-containing flue gas has a pressure of an atmospheric pressure, wherein in the NOₓ-containing flue gas, the oxygen accounts for 4-14 vol %, NOₓ has a concentration of 250-500 ppmv, and the balance is nitrogen.

In some embodiments, the denitration is performed at a temperature of 45-65° C., and preferably 50-60° C. In some embodiments, the denitration is performed at a pH value of 9 to 11, and preferably 9.5 to 10.5.

According to the present disclosure, the iron-containing smelting slag is subjected to carbothermal reduction, such that metals or metal oxides in the smelting slag are reduced and transformed into active catalysts which could activate hydrogen peroxide to generate free radicals. Hydrogen peroxide is catalytically decomposed, generating ·OH free radicals, and ·OH free radicals generated further oxidize NOₓ. The reactions are performed at ambient temperature. The catalyst used is easily available and relatively low in price. The method involves mild reaction conditions, simple operations, and clean products, i.e., H₂O and O₂, without secondary pollution, which conforms to the concept of green development. In the aspect of solid waste recycling, the iron-containing nonferrous metal smelting slag is subjected to carbothermal reduction, and a resulting reduction product could be used for denitration of industrial furnace flue gas, which realizes the concept of “treating waste with waste”. The present disclosure could effectively alleviate the stacking problem of the existing nonferrous metal smelting slags in China, provide a new way for treating the existing nonferrous metal smelting slags, and realize high-value reuse of iron-containing smelting slags.

The methods for denitration of carbothermally reduced iron-containing nonferrous metal smelting slag mixed with advanced oxidizer of the present disclosure will be described in detail with examples below, but they cannot be understood as limiting the scope of the present disclosure.

### Example 1

A pretreated copper slag was provided, wherein the pretreated copper slag contained 55.45% of iron oxides, which mainly existed in the form of olivine (ferrous irons) and magnetite. The copper slag was crushed and ball-milled to obtain a milled slag with a particle size such that the milled slag passed through a 100-mesh screen. The milled slag and lignite (in a mass ratio of 1:0.05) were put into a tube furnace. The tube furnace was continuously heated to a lowest temperature of 600° C. at a heating reate of 10° C./min under nitrogen atmosphere, and maintained at the lowest temperature for 0.5 h. After cooling, the resulting material was collected to obtain a reduction product. The reduction product was mixed with water in a solid-liquid ratio of 1 g:200 mL to obtain a slag slurry. Then, the slag slurry was put into a denitration reactor with a stirring speed of 1200 r/min and a reaction temperature was set at 45° C. A total flow rate from an N₂ cylinder, an O₂ cylinder and an NO/N₂ cylinder was adjusted to 0.4 mL/min, such that in a mixing tank, an O₂ content was 10 vol %, and an NOₓ concentration was 500 ppmv. The gas mixture was used as a simulated flue gas, and introduced into the denitration reactor. Finally, a hydrogen peroxide solution (35% by mass) was added to the slag slurry in an amount of 2 mol hydrogen peroxide per liter of the slag slurry. A resulting system was adjusted to a pH value of 9 with 10 mol/L NaOH. A tail gas was introduced into a flue gas analyzer to test the concentration of NOₓ in the tail gas. After continuous reaction for 6 hours, the NOₓ content retained was 158 ppmv, that is to say, the denitration efficiency was still maintained at 68.4% after 6 hours.

### Example 2

A pretreated copper slag was provided, wherein the pretreated copper slag contained 55.45% of iron oxides, which mainly existed in the form of olivine (ferrous irons) and magnetite. The copper slag was crushed and ball-milled to obtain a milled slag with a particle size such that the milled slag passed through a 100-mesh screen. The milled slag and anthracite (in a mass ratio of 1:0.05) were put into a tube furnace. The tube furnace was continuously heated to a highest temperature of 900° C. at a heating reate of 10° C./min under nitrogen atmosphere, and maintained at the highest temperature for 0.5 h. After cooling, the resulting material was collected to obtain a reduction product. The reduction product was mixed with water in a solid-liquid ratio of 1 g:200 mL to obtain a slag slurry. Then, the slag slurry was put into a denitration reactor with a stirring speed of 1200 r/min and a reaction temperature was set at 45° C. Flow rates from an N₂ cylinder, an O₂ cylinder and an NO/N₂ cylinder were adjusted respectively, such that in a mixing tank, an O₂ content was 10 vol %, and an NOₓ concentration was 500 ppmv. The gas mixture was used as a simulated flue gas at a flow rate of 0.4 mL/min, and introduced into the denitration reactor. Finally, hydrogen peroxide solution (35% by mass) was added to the slag slurry in an amount of 3 mol hydrogen peroxide per liter of the slag slurry. A resulting system was adjusted to a pH value of 9 with 10 mol/L NaOH. A tail gas was introduced into a flue gas analyzer to test the concentration of NOₓ in the tail gas. After continuous reaction for 6 hours, the NOₓ content retained was 102 ppmv, that is to say, the denitration efficiency was still maintained at 79.6% after 6 hours.

### Example 3

A pretreated steel slag was provided, wherein the pretreated steel slag contained 38.01% of iron oxides, which mainly existed in the form of calcium ferrite and RO phase. The steel slag was crushed and ball-milled to obtain a milled slag with a particle size such that the milled slag passed through a 100-mesh screen. The milled slag and lignite (in a mass ratio of 1:0.1) were put into a tube furnace. The tube furnace was continuously heated to 600° C. at a heating rate of 10° C./min, and maintained at 600° C. for 0.5 h, and then the tube furnace was heated to 900° C., during which the milled slag was subjected to carbothermal reduction, and a magnetite was precipitated. After cooling, the resulting material was collected to obtain a reduction product. The reduction product was mixed with water in a solid-liquid ratio of 1 g:200 mL to obtain a slag slurry. Then, the slag slurry was put into a denitration reactor with a stirring speed of 1200 r/min and a reaction temperature was set at 45° C. Flow rates from an N₂ cylinder, an O₂ cylinder and an NO/N₂ cylinder were adjusted respectively, such that in a mixing tank, an O₂ content was 10 vol %, and an NOₓ concentration was 500 ppmv. The gas mixture was used as a simulated flue gas at a flow rate of 0.4 mL/min, and introduced into the denitration reactor. Finally, a hydrogen peroxide solution (35% by mass) was added to the slag slurry in an amount of 2 mol hydrogen peroxide per liter of the slag slurry. A resulting system was adjusted to a pH value of 9 with 10 mol/L NaOH. A tail gas was introduced into a flue gas analyzer to test the concentration of NOₓ in the tail gas. After continuous reaction for 4 hours, the NOₓ content retained was 153 ppmv, that is to say, the denitration efficiency was still maintained at 69.4% after 4 hours.

### Example 4

A pretreated copper slag was provided, wherein the pretreated copper slag contained 55.45% of iron oxides, which mainly existed in the form of olivine (ferrous irons) and magnetite. A pretreated steel slag was provided, wherein the pretreated steel slag contained 38.01% of iron oxides, which mainly existed in the form of calcium ferrite and RO phase. The copper slag and the steel slag (a mass ratio of the copper slag to the steel slag was 2:1) were crushed and ball-milled to obtain a milled slag with a particle size such that the milled slag passed through a 100-mesh screen. The milled slag and lignite (in a mass ratio of 1:0.05) were put into a tube furnace. The tube furnace was continuously heated to 600° C. at a heating rate of 10° C./min, and maintained at 600° ° C. for 0.5 h, and then the tube furnace was heated to 900° C., during which the milled slag was subjected to carbothermal reduction, and a magnetite was precipitated. After cooling, the resulting material was collected to obtain a reduction product. The reduction product was mixed with water in a solid-liquid ratio of 1 g:200 mL to obtain a slag slurry. Then, the slag slurry was put into a denitration reactor with a stirring speed of 1200 r/min and a reaction temperature was set at 45° C. Flow rates from an N₂ cylinder, an O₂ cylinder, and an NO/N₂ cylinder were adjusted respectively, such that in a mixing tank, an O₂ content was 10 vol %, and an NOₓ concentration was 500 ppmv. The gas mixture was used as a simulated flue gas at a flow rate of 0.4 mL/min, and introduced into the denitration reactor. Finally, a hydrogen peroxide solution (35% by mass) was added to the slag slurry in an amount of 3 mol hydrogen peroxide per liter of the slag slurry. A resulting system was adjusted to a pH value of 10 with 10 mol/L NaOH. A tail gas was introduced into a flue gas analyzer to test the concentration of NOₓ in the tail gas. After continuous reaction for 6 hours, the NOₓ content retained was 97 ppmv, that is to say, the denitration efficiency was still maintained at 80.06% after 6 hours.

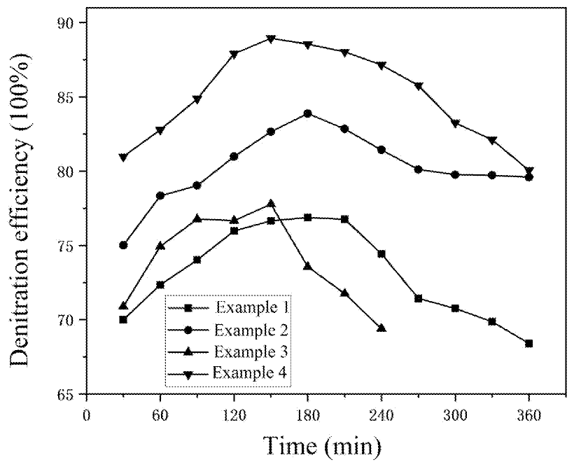

The changes of denitration efficiency over time in Examples 1 to 4 are shown in FIG. 1, and the specific data are shown in Table 1.

TABLE 1
Changes of denitrification efficiency
over time in Examples 1 to 4 (%)

| | Example 1 | Example 2 | Example 3 | Example 4 |
|---|---|---|---|---|
| 30 min | 70.01 | 75.01 | 70.89 | 80.98 |
| 60 min | 72.34 | 78.34 | 74.93 | 82.78 |
| 90 min | 74.03 | 79.03 | 76.77 | 84.87 |
| 120 min | 75.98 | 80.98 | 76.67 | 87.90 |
| 150 min | 76.65 | 82.65 | 77.78 | 88.94 |
| 180 min | 76.88 | 83.88 | 73.56 | 88.54 |
| 210 min | 76.76 | 82.84 | 71.76 | 88.03 |
| 240 min | 74.43 | 81.43 | 69.40 | 87.15 |
| 270 min | 71.43 | 80.11 | — | 85.76 |
| 300 min | 70.76 | 79.76 | — | 83.25 |
| 330 min | 69.87 | 79.72 | — | 82.11 |
| 360 min | 68.40 | 79.60 | — | 80.06 |

From the above examples, it can be seen that, by using the smelting slag after carbothermal reduction as a heterogeneous reagent for wet denitration, the method for denitration of carbothermally reduced iron-containing nonferrous metal smelting slag mixed with advanced oxidizer of the present disclosure could not only realize a reuse of the smelting slag, but also do not produce secondary pollution during the denitration process, and could achieve a good denitration efficiency at low temperature.

The above is only the preferred embodiments of the present disclosure. It should be noted that those skilled in the art could make further improvements and modifications without departing from the conception of the present disclosure. These improvements and modifications all fall within the scope of the present disclosure.

1. A method for denitration of carbothermally reduced iron-containing nonferrous metal smelting slag mixed with advanced oxidizer, comprising:
mixing an iron-containing nonferrous metal smelting slag and a carbon reducing agent to obtain a mixture, and subjecting the mixture to carbothermal reduction at a temperature of 600-900° C. in a protective atmosphere to obtain a reduction product;
mixing the reduction product and water to obtain a slag slurry; and
mixing the slag slurry, a hydrogen peroxide solution, and an NOₓ-containing flue gas to obtain a mixed material, and subjecting the mixed material to denitration.

2. The method of claim 1, wherein in the iron-containing nonferrous metal smelting slag, a mass fraction of iron oxide is in a range of 35-70%, and iron ions mainly exist in the form of ferrous irons in the iron-containing nonferrous metal smelting slag.

3. The method of claim 1, wherein the carbon reducing agent is selected from the group consisting of lignite, anthracite, bituminous coal, and biomass.

4. The method of claim 1, wherein a mass ratio of the iron-containing nonferrous metal smelting slag to the carbon reducing agent is in a range of 1:0.02 to 1:0.16.

5. The method of claim 1, wherein the carbothermal reduction is conducted for 0.5-1.0 h.

6. The method of claim 1, wherein a solid-liquid ratio of the reduction product to water is in a range of 1 g:100 ml to 1 g:250 ml.

7. The method of claim 1, wherein hydrogen peroxide in the hydrogen peroxide solution is in an amount of 1.5 mol to 5 mol per liter of the slag slurry; and the hydrogen peroxide solution has a hydrogen peroxide mass fraction of 35%.

8. The method of claim 1, wherein the NOₓ-containing flue gas has an NOₓ concentration of 250-500 ppmv.

9. The method of claim 1, wherein the denitration is performed at a temperature of 45-65° C. and a pH value of 9-11.

10. The method of claim 1, wherein the carbon reducing agent has a particle size such that the carbon reducing agent passes through a 200-mesh screen.

11. The method of claim 3, wherein a mass ratio of the iron-containing nonferrous metal smelting slag to the carbon reducing agent is in a range of 1:0.02 to 1:0.16.
